(19) United States
(12) Patent Application Publication
(10) Pub. No.: US 2007/0153994 A1
(43) Pub. Date: Jul. 5, 2007

(54) Method and system for integrating an electronic player and a telephone

(75) Inventors: Cheng-Shing Lai, Taipei (TW); Wan-Jun Liu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/646,393

(22) Filed: Dec. 28, 2006

(30) Foreign Application Priority Data
Dec. 29, 2005 (TW) 094147133

(51) Int. Cl. H04M 11/00

(52) U.S. Cl. 379/102.03

(57) ABSTRACT

The present invention is to provide a method and a system for integrating an electronic player and a telephone, which installs a first recording software and a first memory in the telephone and a second recording software and a second memory in the electronic player connected with the telephone through an interface. After the electronic player is connected with a telephone network through the telephone, the telephone will enter into a telephone communication mode. When the telephone receives a recording command, the first recording software and the second recording software will control the electronic player to enter into a recording mode for recording a telephone message and save the telephone message into the second memory, such that a user is able to listen to the message directly from the electronic player anywhere.

### FIELD OF THE INVENTION

The present invention relates to a method and a system for integrating an electronic player and a telephone, and more particularly to a method and a system for integrating an electronic player and a telephone that records and saves telephone messages in the electronic player and allows user to listen to the message anywhere from the electronic player.

### BACKGROUND OF THE INVENTION

At present, there are various types of telephones that use a telephone network for communications. For instance, traditional telephones, including a general telephone, a fax machine, and a wireless telephone, usually have a telephone message recording function that allows users to leave messages on the telephone and listen the messages from the telephone. Since users have to play the message from the telephone and cannot carry the telephone with them all the time, user cannot listen to the message whenever needed.

In recent years, network and communication technologies are developed rapidly, and a player for playing a file format (such as MPEG-1 Layer 3, abbreviated as MP3) established by an audio compression technology becomes a very popular digital electronic product.

MP3 player usually has a recording function, but users do not often use such function. MP3 player generally has a very large memory space. Consumers are happy to have a MP3 player integrated with the foregoing telephone to improve the functions of the MP3 player, but the present telephones cannot be integrated with the MP3 player, and thus the inventor of the present invention came up with the idea of integrating a MP3 player with a telephone. Therefore, the inventor of the present invention based on years of experience to conduct researches and experiments, and finally developed a method and a system for integrating an electronic player and a telephone in accordance with the present invention in hope of bringing convenience to users by such ingenious idea of the present invention.

### SUMMARY OF THE INVENTION

A primary objective of the present invention is to use an electronic player (such as MP3 player), which is a player for playing a file format established by an audio compression technology, having a large memory space for recording a telephone message. Since the electronic player has a portable feature (such as the music walkman) and thus users can listen to the message anytime and anywhere from the electronic player, so as to achieve the purpose of integrating the electronic player with the telephone.

To achieve the foregoing objective, the technical measure taken by the invention is to install a first recording software and a first memory in a telephone and a second recording software and a second memory in an electronic player (such as MP3 player). The telephone and the electronic player are connected by an interface (such as an USB interface), so that after the electronic player is connected to a telephone network through the telephone, the telephone enters into a telephone communication mode. If a recording instruction is received, then the first recording software and the second recording software controls the electronic player to enter into a recording mode for recording a telephone message, and saving the recorded telephone message into the second memory.

To make it easier for our examiner to understand the technical measures and operation procedure of the present invention, we use a preferred embodiment together with the attached drawings for the detailed description of the invention.

### BRIEF DESCRIPTION OF THE DRAWINGS

FIG. 1 is a schematic view of a system architecture of the present invention;

FIG. 2 is a flow chart of a recording a telephone message in a telephone of the present invention; and

FIG. 3 is a flow chart of recording a telephone message in an answering machine of the present invention.

### DETAILED DESCRIPTION OF THE PREFERRED EMBODIMENTS

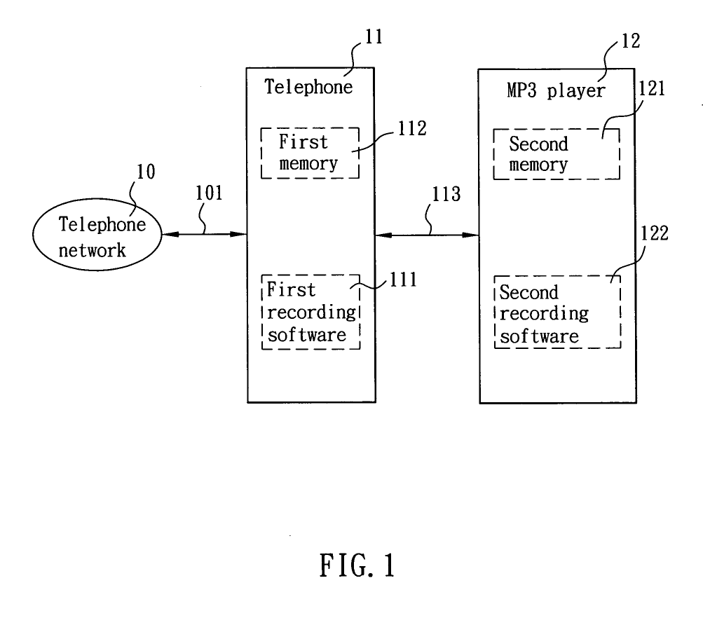

In a preferred embodiment of the method and the system for integrating an electronic player with a telephone in accordance with the present invention, the electronic player, for example, is a player for playing a file format of MPEG-1 Layer 3 (MP3) established by an audio compression technology, and the telephone is, for example, a general telephone, a wireless telephone, or a fax machine, and the MP3 player can be connected to the telephone by an interface such as a universal serial bus (USB) interface. FIG. 1 shows a telephone network 10, the telephone 11, and the MP3 player 12; wherein the telephone 11 includes a first recording software 111, and the MP3 player 12 includes a second recording software 122 and a second memory 121 with a large memory space.

In the foregoing system, the telephone 11 is connected to the telephone network 10 through a telephone line 101, and a USB interface 113 of the telephone 11 is connected to the MP3 player 12, such that when an incoming call of the telephone 11 is not answered by a recipient for a period of time, the telephone 11 will enter into an answering machine operating mode; or when the telephone 11 enters into a telephone recording mode, the first recording software 111 and second recording software 122 will control the MP3 player 12 to record a telephone message and save the recorded telephone message into the second memory 121 of the MP3 player 12 through the USB interface 113. When the MP3 player 12 is removed from the telephone 11, a user can listen to the recorded telephone message whenever needed. Furthermore, the power of the telephone 11 can be utilized for charging the MP3 player 12 through the USB interface 113. In one embodiment of the present invention, the telephone 11 has a first memory 112 with a small memory space, when the telephone 11 is not connected with the MP3 player 12, the telephone 11 will record and save the telephone message in the first memory 112.

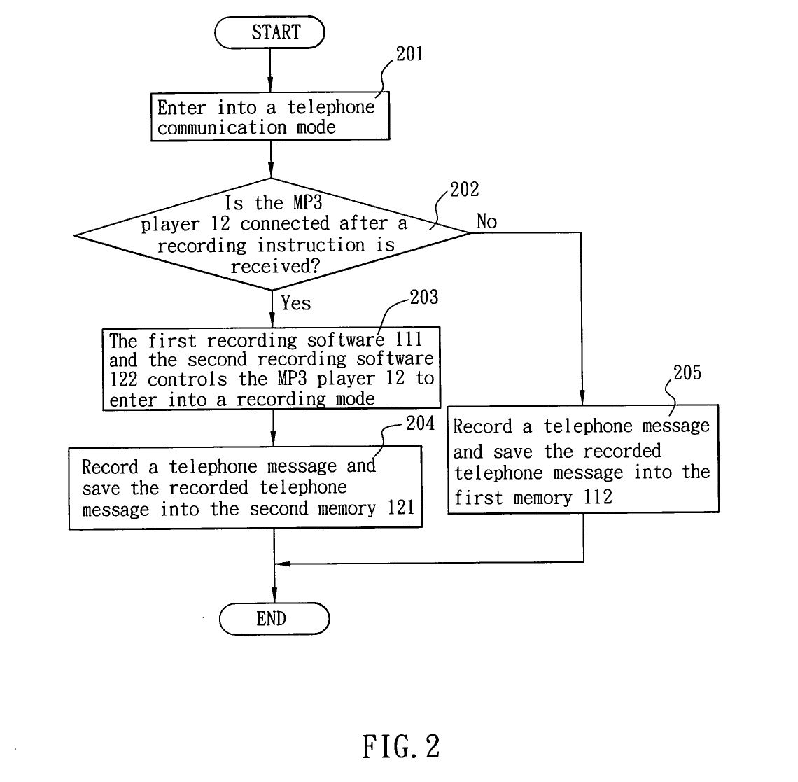

After the MP3 player 12 and the telephone 11 are connected by the USB interface 113 to establish a connection with the telephone network 10, the steps of a procedure as shown in FIG. 2 are processed as follows:

In Step 201, the telephone 11 enters into a telephone communication mode.

In Step 202, when the telephone 11 receives a recording instruction (for example, generated by pressing a recording key on the telephone 11 by a user or generated by a recording option installed in the telephone 11 for recording telephone calls), the telephone 11 determines whether or not the MP3 player 12 is connected with the telephone 11; if the MP3 player 12 is connected with the telephone 11, Step 203 will be executed; and if the MP3 player 12 is not connected with the telephone 11, then Step 205 will be executed.

In Step 203, the first recording software 111 and the second recording software 122 controls the MP3 player 12 to enter into a recording mode.

In Step 204, the MP3 player 12 records a telephone message and saves the recorded telephone message into the second memory 121, the recorded telephone message could be stored in a specific recording directory of the MP3 player 12 for facilitating user's management); and then the recording is stopped when the telephone call is ended.

In Step 205, the first recording software 111 of the telephone 11 records a telephone message, and saves the recorded telephone message into the first memory 112; and then the recording is stopped when the telephone call is ended.

Therefore, users can play the recorded telephone message stored in the MP3 player 12, and also can remove the MP3 player 12 from the telephone 11 to directly listen to the recorded telephone message anytime and anywhere from the MP3 player 12, and even save the recorded telephone message in a personal computer (PC) for data backup management.

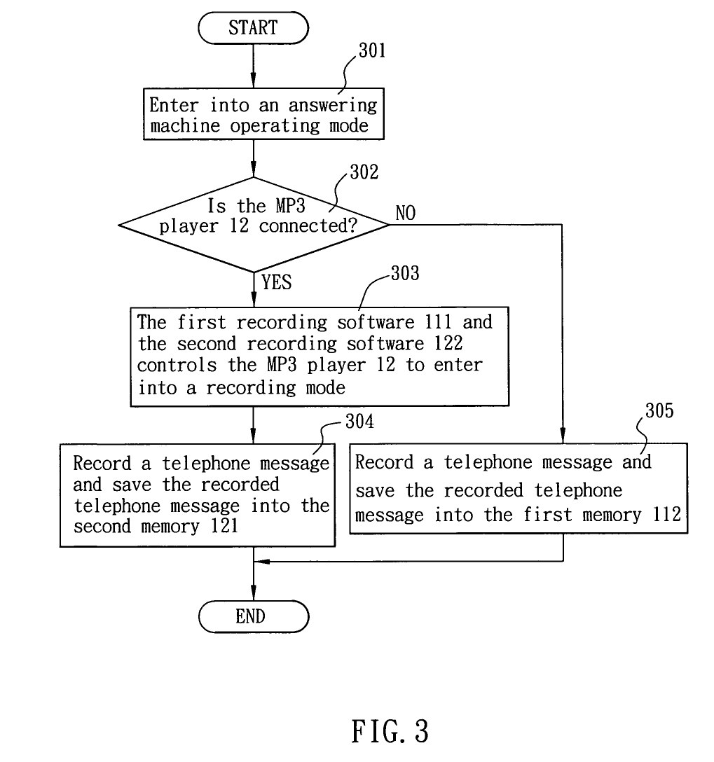

After the MP3 player 12 and the telephone 11 are connected through the USB interface 113 to establish a telephone connection with the telephone network 10 in accordance with the present invention, the following steps of a procedure as shown in FIG. 3 will be processed when the telephone 11 receives an incoming call and not answer the incoming call for a period of time:

In Step 301, the telephone 11 enters into an answering machine operating mode.

In Step 302, the telephone 11 determines whether or not the MP3 player 12 is connected thereto; if the MP3 player 12 is connected to the telephone 11, then Step 303 will be executed; and if the MP3 player 12 is not connected to the telephone 11, then Step 305 will be executed.

In Step 303, the first recording software 111 and the second recording software 122 controls the MP3 player 12 to enter into a recording mode.

In Step 304, the MP3 player 12 records a telephone message and saves the recorded telephone message into the second memory 121; and then the recording is stopped when the telephone call is ended.

In Step 305, the first recording software 111 of the telephone 11 records a telephone message, and saves the recorded telephone message in the first memory 112; and then the recording is stopped when the telephone call is ended.

Similarly, users can play the recorded telephone message saved in the MP3 player 12 and also can remove the MP3 player 12 from the telephone 11 to directly listen to the recorded telephone message from the MP3 player anytime and anywhere, and even save the recorded telephone message in a personal computer (PC) for data backup management.

While the invention herein disclosed has been described by means of specific embodiments, numerous modifications and variations could be made thereto by those skilled in the art without departing from the scope and spirit of the invention set forth in the claims.

What is claimed is:

1. A method for integrating an electronic player and a telephone, wherein said electronic player is a player for playing a file format established by an audio compression technology, said method comprising the steps of:
connecting said electronic player with said telephone;
said telephone entering into a telephone communication mode;
said telephone receiving a recording instruction;
said electronic player entering into a recording mode; and
said electronic player recording a telephone message, and then saving the telephone message into a memory of said electronic player.

2. The method of claim 1, wherein said interface is a universal serial bus (USB) interface.

3. The method of claim 1, wherein said electronic player is a MP3 player.

4. The method of claim 1, wherein said telephone is a general telephone, a wireless telephone, or a fax machine.

5. A method for integrating an electronic player and a telephone, wherein said electronic player is a player for playing a file format established by an audio compression technology, said method comprising the steps of:
connecting said electronic player with said telephone;
said telephone receiving an incoming call and not answering the incoming call;
said telephone entering into an answering machine operating mode;
said electronic player entering into a recording mode; and
said electronic player recording a telephone message, and then saving the telephone message into a memory of said electronic player.

6. The method of claim 5, wherein said interface is a universal serial bus (USB) interface.

7. The method of claim 5, wherein said electronic player is a MP3 player.

8. The method of claim 5, wherein said telephone is a general telephone, a wireless telephone, or a fax machine.

9. A system for integrating an electronic player and a telephone, comprising:
a telephone, comprising a first recording software and an interface; and
an electronic player, comprising a second recording software and a memory, connected with said telephone through said interface;
wherein, when said telephone receives an incoming call, said first recording software and said second recording software control said electronic player to enter into a recording mode, and then said electronic player records a telephone message of the incoming call and saves the telephone message into said memory.

10. The system of claim 9, wherein when said telephone answering the incoming call, said electronic player starts to record said telephone message.

11. The system of claim 9, wherein when said telephone not answering the incoming call for a period of time, said telephone will enter into an answering machine mode and said electronic player will start to record said telephone message into said memory.

12. The system of claim 9, wherein said interface is a universal serial bus (USB) interface.

13. The system of claim 9, wherein said electronic player is a MP3 player.

14. The system of claim 9, wherein said telephone is a general telephone, a wireless telephone, or a fax machine.
